(19) United States
(12) Patent Application Publication
(10) Pub. No.: US 2013/0095794 A1
(43) Pub. Date: Apr. 18, 2013

(54) REAL-TIME MANAGEMENT OF A WIRELESS DEVICE OPERATION ON MULTIPLE NETWORKS

(71) Applicant: SignalSet, Inc., Seattle, WA (US)

(72) Inventors: Ruskin Taylor Lhamon, Seattle, WA (US); Andrew W. Buffmire, Salt Lake City, UT (US)

(73) Assignee: SignalSet, Inc., Seattle, WA (US)

(21) Appl. No.: 13/650,934

(22) Filed: Oct. 12, 2012

Related U.S. Application Data
(60) Provisional application No. 61/546,943, filed on Oct. 13, 2011.

(51) Int. Cl. H04W 12/06

(52) U.S. Cl. 455/411

(57) ABSTRACT

A wireless device is configured to operate on a variety of service providers' wireless communication networks based on various defined rules. A SIM may store or encode information and algorithms proprietary to two or more service providers. A wireless communication device with a configuration profile selected based on a particular selection of a wireless network may be remotely configured based on one or more selection criteria or defined rules. A SIM may generate a response to authentication requests using the appropriate authentication information and algorithms stored on the SIM. A wireless communication device may self-select a service provider wireless communication network and self configure with a corresponding configuration profile. Configuration or selection may be based on a defined relationship between an application and a particular device provider.

### BACKGROUND

Wireless communication devices, for example, cellular telephones, smartphones, and wireless personal digital assistants, automated electronic equipment—commonly known as “machine-to-machine” equipment, provide access to a variety of communication services. Communication services include, for example, voice communication, text messaging, data, Internet access, and electronic mail. Wireless communication service providers (i.e., carriers) enable mobile wireless communication devices to access different resources through a wireless communication network. Typically, wireless communication devices may be customized for use on a particular wireless communication network provided by a particular service provider (sometimes called a “home network” in contrast to other networks on which the device may also operate while incurring roaming charges). The wireless communication network is typically limited to a specific country and/or geographic region. Device customization involves loading information (e.g., operational parameters specific to the wireless communication service provider) on the wireless communication device. For example, installation of a subscriber identity module (SIM) may configure a wireless communication device to operate on a particular carrier's wireless communication network which is compliant with Global System Mobile Communication (GSM) protocols.

Wireless communication devices typically have a memory component, called a subscriber identity module (SIM), commonly referred to as a SIM card. SIMs are typically a removable smart card. SIMs are commonly employed in wireless communication devices operating in Global System for Mobile Communications (GSM), Universal Mobile Telecommunication System (UMTS), and Code Division Multiple Access (CDMA) networks. Each SIM contains or encodes user information and service parameters that pertain to a particular wireless communication service provider. CDMA-based wireless communication devices originally did not use a removable card. The service for these early CDMA-based phones was bound to a unique identifier irretrievably stored and contained in the handset memory dedicated to storing the SIM-related information. This non-removable approach has been most prevalent in operators in the Americas. However, the TIA-820 standard (also known as 3GPP2 C.S0023) issued in 2000 defined a CDMA compliant Removable User Identity Module (R-UIM). According to the standard, a Removable User Identity Module is a card developed for CDMA handsets that extends the GSM SIM card to CDMA phones and networks. Card-based CDMA devices are most prevalent in Asia. The equivalent of a SIM in UMTS is called the Universal Integrated Circuit Card (UICC). References herein and in the claims to SIMs means any integrated circuit that stores subscriber identity information and carrier specific wireless communication network information necessary to establish communication via the carrier's wireless communication network, without regard to the specific designation assigned to the integrated circuit under the relevant protocol. Thus, a SIM may include R-UIMs, UICCs, or other current or future formats and standards.

Typically, a SIM is an integrated circuit that securely stores information used to identify network-specific information used to authenticate and identify subscribers on the network. For example, a typical GSM SIM card contains its unique serial number (ICCID), internationally unique number of the mobile user (IMSI), security authentication and ciphering information, temporary information related to the local network, a list of available services, and one or more passwords, such as a personal identification number (PIN). Portions of the IMSI can be used to configure the wireless communication device for a particular wireless communication service provider's network. SIMs are available in a variety of different formats with respective physical characteristics. Some formats include ID-1, ID-000, Multi-UICC, embedded SIMs, and the like.

In order to access a particular wireless communication network, the wireless communication device is authenticated by the service provider. Authentication is a process of exchanging information between a wireless communication device and the wireless communication network equipment which allows the service provider to confirm the true identity of the user or device. This validation of the authenticity of the user and/or wireless communication device allows a service provider to deny service to users that cannot be identified. The authentication process involves security authentication information embedded in the SIM, such as a secret authentication key and an authentication algorithm. Typically, the authentication key is hard-coded into a SIM and may not be changed or extracted from the SIM. The authentication algorithm may also be hard-coded in the SIM.

By way of example, the GSM authentication process starts with the transmission of a random number from a base station within the operational range of a wireless communication device. This random number (“challenge value” in the analogous CDMA authentication procedure) is used, along with other information including the secret data value (e.g., authentication key) to calculate a signed response (“challenge response” in the analogous CDMA authentication procedure) using the authentication algorithm. As described above, the secret authentication key is stored in both the SIM of the wireless communication device and in the service provider's system, and is not transmitted over the radio link between the base station and the wireless communication device. The service provider's system performs the authentication process by comparing the calculated signed response to the signed response returned by the wireless communication device. If both signed responses match, the service provider's system allows the wireless communication device to access the service provider's wireless communication network. The codes generated in the authentication may be used for voice privacy (encryption) mode as well. Similar methods of authentication are used on CDMA networks.

However, it may be preferable to use a wireless communication device on different wireless networks provided by different wireless communication service providers depending on particular usage parameters (e.g., type of data, time of day—geographic location of the device, cost of usage, and the like). Currently, the use of a wireless communication device on different networks is limited to the custom configuration information associated with the device and provided by a device manufacturer. Furthermore, changing customization information in order to use the same device on a network different than the device's “home” network often requires manual intervention. For example, replacement of a SIM may be necessary to switch to another carrier's wireless communication network.

### SUMMARY

A SIM associated with a wireless communication device may have more than one portion of security authentication information (e.g., authentication key) irretrievably embedded in the SIM. Each portion may have security authentication information required to authenticate a wireless communication device with a respective one of a plurality of different service providers' communication networks. For example, a SIM may have a first security authentication key and/or first authentication algorithm required for authenticating the device with a first service provider's wireless communication network (e.g., first GSM network) and a second security authentication key and/or second authentication algorithm required for authenticating the device with a second service provider's wireless communication network (e.g., second GSM network or CDMA network). A wireless communication device having such a SIM may be configured to, in response to an authentication request, determine which wireless service provider's network sent the request, and select the appropriate portion of security information needed to respond to the authentication request. Other ways of determining which wireless service provider's network to use include: a determination of the network via remote control, a determination of the network based on an application executing or selected to execute on a wireless device or selected for execution remotely and communicating with the wireless device, a determined network priority list associated with the wireless device, service provider, or third party, and the like. In addition to selecting which specific network to use, the selection may include a priority of networks to use, thereby enabling the dynamic choice between available networks based on which networks are “visible” to the device at any one place and or time.

A wireless communication device may also store a plurality of wireless network configuration profiles. The configuration profiles may be preloaded to the device, for example, remotely. A wireless network configuration profile may include settings customized to configure a wireless communication device to operate on a wireless communication network associated with a particular service provider as the home wireless communication network. Thus, the configuration profiles may allow the wireless communication device to automatically operate with two or more service providers' wireless communication networks as the home wireless communication networks. Switching may be automatic, and may be based on a variety of criteria, for example, geographic location, network speed, rates and costs for usage, network availability, response times, signal strength, and/or various other defined rules. At least a part of the configuration profiles may, for example, be stored in the device memory, while the remaining part may be stored in the SIM. Alternatively, configuration profiles may be wholly stored in either the device memory or in the SIM.

A wireless communication device may be remotely configured with a configuration profile corresponding to one of a plurality of different service providers' wireless communication networks selected for the device based on one or more selection criteria. The selection criteria may include, but are not limited to, defined rules. Defined rules may include utilizing a particular network at a certain time/date or set of times/dates, particular location(s), for a certain type of data (e.g., high priority data versus low priority data, international data versus local data, and the like). The defined rules may further include utilizing a particular network based on accessible base stations, quality of transmission and reception, and so on. The defined rules may further include utilizing a particular network that would enable a particular application that is executing remotely to communicate with the wireless device. Other selection criteria may also be employed. Once a network that most closely matches the selection criteria is selected, a command may be sent directing the device to be configured with a stored configuration profile corresponding to the selected network.

A wireless communication device may self-select a service provider's wireless communication network that corresponds to one or more selection criteria. The criteria may include, but are not limited to, the defined rules described above. Selection criteria may include assigning or logically associating a software application which will execute on the wireless communication device with a particular service provider wireless communication network over which the particular software application will correspond. An application may control which network (or priority of networks) to use with the wireless communication device. An application may also control a change over time in networks used for communications by the wireless communication device.

A method of operating a subscriber identity module associated with a wireless communication device may be summarized as including, in response to receiving a first authentication request from an authentication system under control of a first wireless communication network service provider including a first challenge value, producing a first challenge response by the subscriber identity module via a first authentication algorithm based at least in part on the received first challenge value and a first secret authentication key irretrievably embedded in the subscriber identity module, the first authentication algorithm associated with the first wireless communication network service provider, the secret authentication key and the first challenge value associated with at least the authentication system under the control of the first wireless communication network service provider; and in response to receiving a second authentication request from an authentication system under control of a second wireless communication network service provider including a second challenge value, producing a second challenge response by the subscriber identity module via a second authentication algorithm based at least in part on the received second challenge value and a second secret authentication key irretrievably embedded in the subscriber identity module, the second authentication algorithm associated with the second wireless communication network service provider and not associated with the first wireless communication network service provider, the second secret authentication key and the second challenge value associated with at least the authentication system under the control of the second wireless communication network service provider.

The first and the second wireless communication network service providers may be associated with first and a second wireless communication networks respectively. The first and the second wireless communication networks may be selected from at least one of a GSM network and a CDMA network. The subscriber identity module may be selected from at least one of a GSM SIM card, an R-UIM card, or a portion of a wireless communication device memory dedicated to storing information associated with the subscriber identity module. The subscriber identity module may irretrievably embed the first and the second authentication algorithms. The subscriber identity module may access the first and the second authentication algorithms that are stored outside of the subscriber identity module.

A wireless communication device may be summarized as including a subscriber identity module that irretrievably embeds at least a first and a second secret authentication key in the subscriber identity module, the first secret authentication key associated with a first wireless communication network service provider, the second secret authentication key associated with a second wireless communication network service provider, the subscriber identity module having access to at least first and second authentication algorithms, the first authentication algorithm associated with the first wireless communication network service provider, the second authentication algorithm associated with the second wireless communication network service provider and not associated with the first wireless communication network service provider, wherein the subscriber identity module is configured to: in response to receiving a first authentication request from an authentication system under control of the first wireless communication network service provider including a first challenge value, produce a first challenge response by the subscriber identity module via the first authentication algorithm based at least in part on the received first challenge value and the first secret authentication key; and in response to receiving a second authentication request from an authentication system under control of the second wireless communication network service provider including a second challenge value, produce a second challenge response by the subscriber identity module via the second authentication algorithm based at least in part on the received second challenge value and the second secret authentication key, wherein the first secret authentication key and the first challenge value are associated with the authentication system under the control of the first wireless communication network service provider, and wherein the second secret authentication key and the second challenge value are associated with at least the authentication system under the control of the second wireless communication network service provider.

The subscriber identity module may irretrievably embed the first and second authentication algorithms. The subscriber identity module may access the first and second authentication algorithms that are stored outside of the subscriber identity module.

A non-transitory computer-readable medium may be summarized as residing on a subscriber identification module and having instructions for first and second authentication algorithms stored thereon, the first authentication algorithm associated with a first wireless communication network service provider, the second authentication algorithm associated with a second wireless communication network service provider and not associated with the first wireless communication network service provider, wherein the instructions, when executed by the subscriber identification module, cause the subscriber identification module to: in response to receiving a first authentication request from an authentication system under control of the first wireless communication network service provider including a first challenge value, produce a first challenge response via the first authentication algorithm based at least in part on the received first challenge value and a first secret authentication key irretrievably embedded in the subscriber identity module; and in response to receiving a second authentication request from an authentication system under control of the second wireless communication network service provider including a second challenge value, produce a second challenge response by the subscriber identity module via the second authentication algorithm based at least in part on the received second challenge value and a second secret authentication key irretrievably embedded in the subscriber identity module, wherein the first secret authentication key and the first challenge value are provided by at least the authentication system under the control of the first wireless communication network service provider, and wherein the second secret authentication key and the second challenge value are provided by at least the authentication system under the control of the second wireless communication network service provider.

A method for remotely configuring a wireless communication device may be summarized as including causing, by at least one computer system, a plurality of configuration profiles for respective ones of each of a plurality of wireless networks to be stored on a wireless communication device; determining, by the at least one computer system, which of the plurality of wireless networks corresponds to one or more defined wireless network selection criteria; and remotely configuring, by the at least one computer system, the wireless communication device with one of the stored configuration profiles which corresponds to the determined wireless network, the configuration profile configuring the wireless communication device for wireless communication over the determined wireless network.

The method for remotely configuring a wireless communication device may further include sending an update to the configuration profiles to the wireless communication device; and causing the update to be associated with a corresponding at least one of the configuration profiles.

The update may be sent via at least one of a wireless communication network on which the device currently operates, a Wi-Fi network, or a direct wired connection. Determining which of the plurality of wireless networks corresponds to one or more defined wireless selection criteria may include determining which of the plurality of wireless networks is logically associated with one or more software applications executing remotely on the at least one computing system or on a second computing system associated with the wireless communication device. The one or more software applications may be provided by a third party via the at least one computing system. Remotely configuring the wireless communication device with one of the stored configuration profiles may change a home wireless communication network of the wireless communication device.

A computer system for remotely configuring a wireless communication device may be summarized as including at least one processor; and at least one memory having computer-executable instructions that, when executed on the at least one processor, cause the at least one processor to: cause a plurality of configuration profiles for respective ones of each of a plurality of wireless networks to be stored on a wireless communication device; determine which of the plurality of wireless networks corresponds to one or more defined wireless network selection criteria; and remotely configure the wireless communication device with one of the stored configuration profiles which corresponds to the determined wireless network, the configuration profile configuring the wireless communication device for wireless communication over the determined wireless network.

A non-transitory computer-readable medium may be summarized as having computer-executable instructions for remotely configuring a wireless communication device stored thereon that, when executed by a computer, cause the computer to: cause a plurality of configuration profiles for respective ones of each of a plurality of wireless networks to be stored on a wireless communication device; determine which of the plurality of wireless networks corresponds to one or more defined wireless network selection criteria; and remotely configure the wireless communication device with one of the stored configuration profiles which corresponds to the determined wireless network, the configuration profile configuring the wireless communication device for wireless communication over the determined wireless network.

A method for configuring a wireless communication device may be summarized as including detecting, by at least one processor, a selection of a first application on the wireless communication device, the first application being selected from one or more applications associated with the device; selecting, by the at least one processor, a first wireless communication network from a plurality of wireless communication networks based on the selected first application; and establishing, with the at least one processor, wireless communication for the selected first application over the selected wireless communication network by the wireless communication device.

The method for configuring a wireless communication device may further include configuring the wireless communication device with a stored configuration profile corresponding to the selected wireless communication network before establishing wireless communication for the first application over the selected wireless communication network.

At least one of the one or more applications may be associated with a provider of at least one of the plurality of wireless communication networks. At least a subset of the one or more applications may be selected from an application store maintained by a third party. Establishing wireless communication for the selected first application may include establishing wireless communication as a home wireless communication network. Selecting a first wireless communication network from a plurality of wireless communication networks based on the selected first application may further include selecting a wireless communication network priority governed by the selected first application.

A computer system for configuring a wireless communication device may be summarized as including at least one processor; and at least one memory having computer-executable instructions that, when executed on the at least one processor, cause the at least one processor to: detect a selection of a first application on the wireless device, the first application being selected from one or more applications associated with the device; select a first wireless communication network from a plurality of wireless communication networks based on the selected first application; and establish wireless communication for the selected first application over the selected wireless communication network by the wireless communication device.

A non-transitory computer-readable medium may be summarized as having computer-executable instructions for configuring a wireless communication device stored thereon that, when executed by a computer, cause the computer to: detect a selection of a first application on the wireless communication device, the first application being selected from one or more applications associated with the wireless communication device; select a first wireless communication network from a plurality of wireless communication networks based on the selected first application; and establish wireless communication for the selected first application over the selected wireless communication network by the wireless communication device.

### BRIEF DESCRIPTION OF THE DRAWINGS

FIG. 1 is a schematic diagram showing an environment in which various embodiments can be implemented, according to one illustrated embodiment.

FIG. 2 is a schematic diagram showing an exemplary wireless communication device with which various embodiments may be practiced, according to one illustrated embodiment.

FIG. 3 is a flow diagram showing a method of real-time management of a wireless device operation on multiple networks in accordance with an illustrated embodiment.

FIG. 4 is a flow diagram showing a method of real-time management of a wireless device operation on multiple networks in accordance with another illustrated embodiment.

FIG. 5 is a flow diagram showing a method of real-time management of a wireless device operation on multiple networks in accordance with yet another illustrated embodiment.

### DETAILED DESCRIPTION

Apparatuses and methods for providing real-time management of a wireless communication device on multiple wireless networks are described herein. In a wireless network-based environment (e.g., cellular communication network), a variety of different wireless communication devices provide various types of communication, including voice, text, messaging, data, Internet, electronic emails, and other types of communication services. Wireless communication devices can also run a variety of software applications that provide additional services to users. Wireless communication devices most commonly take the form of handheld devices (e.g., pocket-sized or tablet sized), typically having a display screen, often with touch input and/or a keyboard or keypad.

However, wireless communication devices are not necessarily limited to handheld form factors. For example, machine-to-machine (M2M) wireless devices may use transducers (such as a sensor) to sense a physical characteristic (e.g., temperature, inventory level, speed, light level) or an event. Sensed information may be relayed through a network (e.g., wireless, wired, or hybrid) to an application (e.g., a software program), that translates the sensed information or event into more meaningful information.

Wireless communication devices may be configured to communicate on a variety of different types of networks, including but not limited to wireless or wired Internet-based networks, wireless or wired proprietary networks, Wi-Fi networks, Bluetooth®, ZigBee®, wireless cellular networks, wireless satellite networks, Universal Serial Bus (USB)-based networks, Recommended Standard 232 (RS-232)-based networks, Controller-area (CAN-bus)-based networks, and the like.

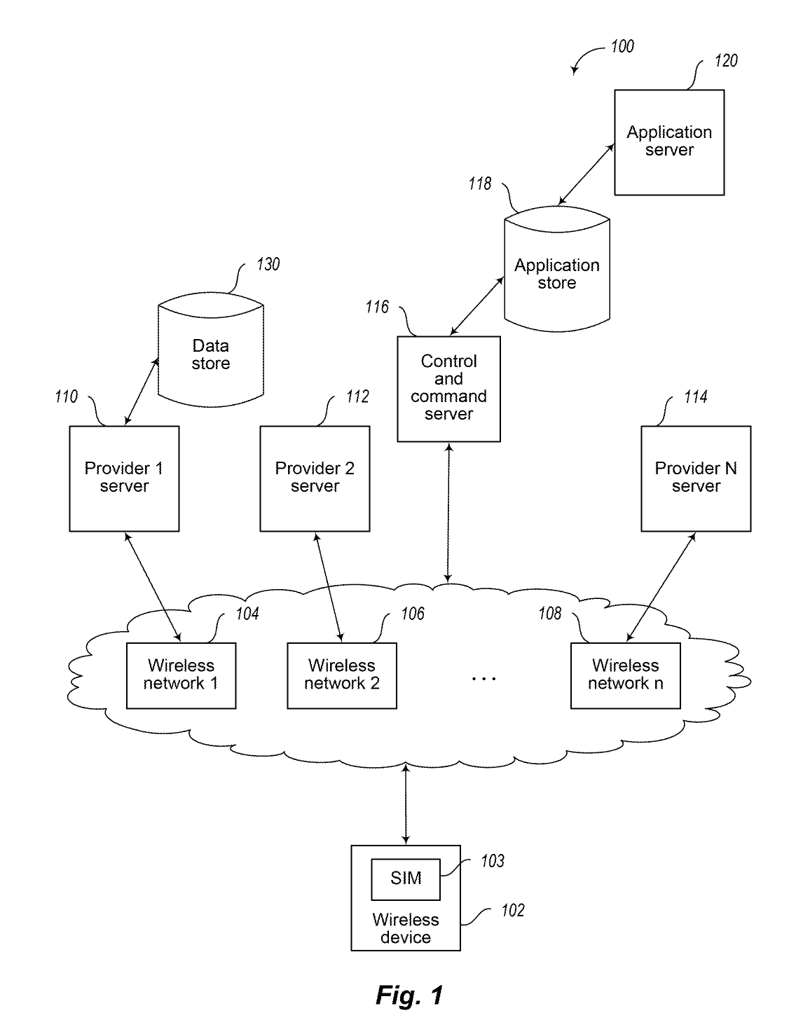

FIG. 1 illustrates an example of an environment 100 for implementing aspects in accordance with various embodiments. As will be appreciated, although a wireless communication-based environment is used for purposes of explanation, different environments may be used, as appropriate, to implement various embodiments. The environment 100 includes a wireless communication device 102, which can include any device operable to communicate (e.g., send and receive voice or data information, text messages, or other types of information), over a wireless communication network 104, 106, 108 and convey information back to a user (or a machine, as the case may be) associated with the wireless communication device. Examples of such wireless communication devices include personal computers, cell phones, handheld messaging devices, laptop computers, set-top boxes, personal data assistants, electronic book readers, tablet computers, and the like. The device 102 may have a subscriber identity module 103. The wireless communication networks 104, 106, 108 may include any appropriate network, including a cellular network, a local area network, or any other such network or combination thereof. A wireless communication network on which the wireless communication device may operate may be selected from a plurality of networks 104, 106, 108 as described below in greater detail.

Components used for such a system can depend at least in part upon the type of wireless communication network and/or environment selected. Protocols and components for communicating via such a wireless communication network are well known and will not be discussed herein in detail. Communication over the wireless communication network can be enabled by wired or wireless connections, and combinations thereof. In this example, the wireless communication networks include different types of wireless communication networks (e.g., GSM, CDMA, satellite, Wi-Fi, and the like), and the environment includes one or more servers 110, 112, 114, 116, 120 for providing wireless services, command and control over the device 102, and serving content (e.g., software applications stored in an application data store 118). Different configurations of the environment 100 may be utilized for the purposes of the present disclosure, as would be apparent to one of ordinary skill in the art. The environment 100 may further include one or more base stations (not shown) that facilitate voice and data transmission between wireless communication devices over a wireless communication network associated with the base stations. Base stations may be used, for example, for modulation, demodulation, coding, decoding, encryption and decryption of the data traffic flowing through the stations.

The illustrative environment includes at least one application server 120 and a data store 118. It should be understood that there can be several application servers, layers, or other elements, processes, or components, which may be chained or otherwise configured, which can interact to perform tasks such as obtaining data from an appropriate data store. As used herein, the term “data store” refers to any device or combination of devices capable of storing, accessing, and retrieving data, which may include any combination and number of data servers, databases, data storage devices, and data storage media, in any standard, distributed, or clustered environment. The application server 120 can include any appropriate hardware and software for integrating with the data store as needed to execute aspects of one or more applications for the client device, handling a majority of the data access and business logic for an application. One or more servers, such as wireless service provider servers 110, 112, 114 may be associated with one or more data stores, such as a data store 130. For simplicity purposes, only one data store is shown in FIG. 1. It should be understood that a number of data stores may be utilized. The data store 130 can include several separate data tables, databases, or other data storage mechanisms and media for storing data relating to a particular aspect. For example, the data store may include mechanisms for storing production data and user information, which may be used to provide wireless services to users via provider servers 110, 112, 114. The data store 130 may include a mechanism for storing log data, which can be used for reporting, generating statistics, and other such purposes. The data store 130 may be operable, through logic associated therewith, to receive instructions from the provider server 110 and obtain, update, or otherwise process data in response thereto.

Each service provider server 110, 112, 114 may be associated with a corresponding wireless network, e.g., 104, 106, and 108, respectively. However, more than one provider and consequently provider servers may be associated with a particular wireless network (not shown). As an example, different “home” network providers may allow roaming on other networks. Accordingly, selecting or switching home networks for a wireless communication device described herein may control the mode of roaming of the device on other networks. Each server may include an operating system that provides executable program instructions for the general administration and operation of that server, and typically may include a computer-readable medium storing instructions that, when executed by a processor of the server, allow the server to perform its intended functions. The control and command server 118 may be operated by an entity associated with, and/or different from, wireless network service providers operating servers 110, 112, 114.

In an embodiment, the control and command server 118 may be configured to remotely command and control the wireless device 102 to operate on a particular network selected from the networks 104, 106, 108. The server 118 may be configured to communicate with the application store 118 via the application store 120. The command and control server 118 may be further configured to serve software applications that may be executed remotely on the server and communicate with the device 102 via one of the networks 104, 106, 108 selected by the server 118. In an embodiment, the server 118 may facilitate communication of the applications residing on the wireless device with other systems, entities, and/or devices (not shown) via a network selected from the networks 104, 106, 108. Suitable implementations for the operating system and general functionality of the servers are known or commercially available, and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 1. Thus, the depiction of the system 100 in FIG. 1 should be taken as being illustrative in nature, and not limiting to the scope of the disclosure.

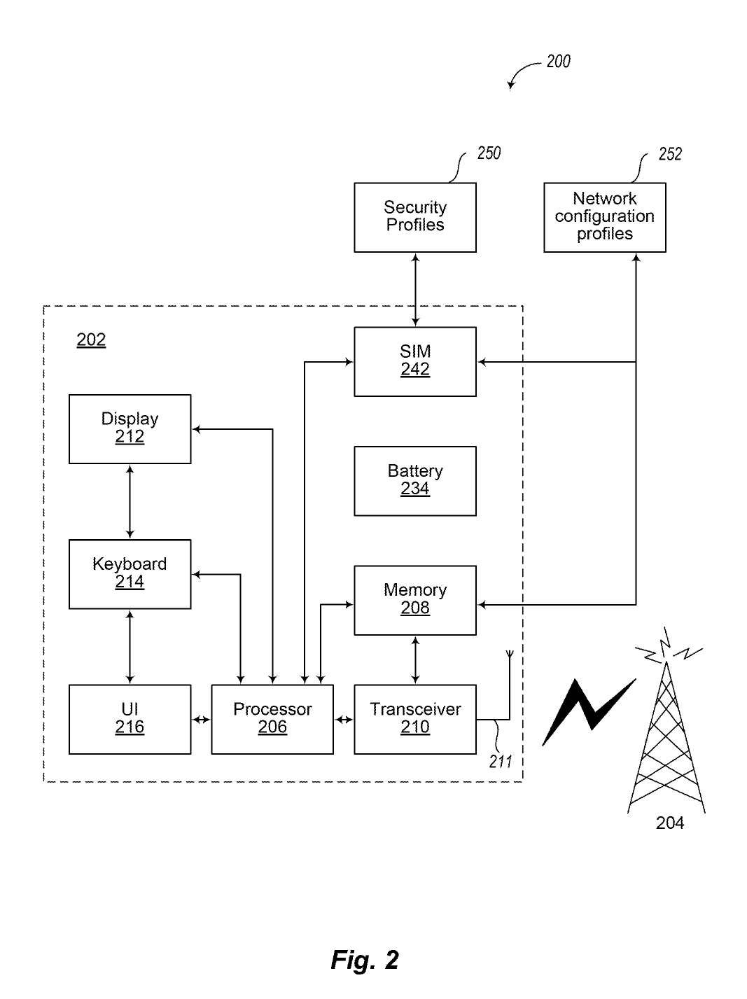

FIG. 2 shows a block diagram 200 of a wireless communication device 202, according to one illustrated embodiment. It should be understood that wireless communication device 202 may include personal computers, cell phones, handheld messaging devices, laptop computers, personal data assistants, and the like. While the device 202 may be configured to utilize a wireless communication network symbolized by a base station 204, it should be understood that any suitable communication network may be used as an alternative to or in addition to wireless networks. It should be understood that other networks may be used as an alternative to or in addition to the network symbolized by the base station 204. Examples of other networks include mobile networks, intranets, Wi-Fi networks, home networks, corporate networks, and generally any suitable communication network including direct serial links through RS-232, USB, or other serial links.

In an embodiment, a wireless communication device 202 may include a number of components described herein. It is to be understood that the following description is merely illustrative and in no way limiting this disclosure. Different elements may or may not be included in a wireless communication device on which the described embodiments may be implemented. For example, the device 202 may (although does not have to) include a display 212, a keyboard 214, and one or more auxiliary user interfaces (UI) 216, each of which may be coupled to a processor 206. The processor 206 is also coupled to radio frequency transceiver circuitry 210 and an antenna 211 (in an embodiment, one or more transceivers and/or one or more associated antennae). Typically, the processor 206 is configured to run operating system software stored in a memory component 208. The processor 206 may control overall operation of wireless device 202, and signal processing associated with communication functions may be performed by the transceiver circuitry 210 or the processor 206. The processor 206 may interface with device display 212 to display received information, stored information, user inputs, and the like. In one example, the display 212 may include touch screen functions. The keyboard 214 is normally provided for entering user input, such as data for storage in wireless device 202, information for transmission to the wireless network through the base station 204, a telephone number, commands to be executed on wireless device 202, and the like. For example, the user may select an application stored in the memory 208 to execute on the processor 206 of the device.

Wireless device 202 may send communication signals to and receive communication signals from the wireless network over a wireless link via one or more antennae 211. RF transceiver circuitry 210 performs signal processing functions, including, for example, modulation/demodulation and possibly encoding/decoding and encryption/decryption. Wireless device 202 operates using a SIM 242. As discussed above, the SIM 242 may be a conventional “smart card” used to identify an end user (or subscriber) of wireless device 202 and to authenticate the wireless communication device 202, among other things. The processor 206 may be further configured to retrieve a wireless configuration profile from a plurality of wireless service configuration profiles 250 stored at least in part in the memory 208 of the wireless communication device 202 and/or in the SIM 204. Wireless service configuration profiles may include settings customized for configuring the wireless communication device 202 to operate on a particular service provider's wireless communication network as a home wireless communication network.

The device 202 may not necessary always be directly accessing its home wireless network. For example, the device may be roaming on a wireless communication network which is a selected “roaming partner” network to the configured home network. In this case, the home network selection may guide which networks the device will roam on based on the “home” network roaming partners. Each home network provider has separate “roaming” arrangements with other wireless carriers. Selection of the appropriate “home” network to configure the device to use, when roaming, includes understanding of which roaming partner network this home network will use, and possibly including this in the decision of which home network to configure the device to use.

As described above, the wireless communication device 202 may be configured remotely or self-configured depending on a particular wireless communication network that may be selected from a plurality of available wireless communication networks for the operation of the wireless communication device based on particular wireless communication criteria. The wireless communication device 202 may be further configured to authenticate on a particular network using authentication information that may be selected in response to an authentication request from a particular service provider's authentication system from a plurality of authentication data irretrievably stored on the SIM 204.

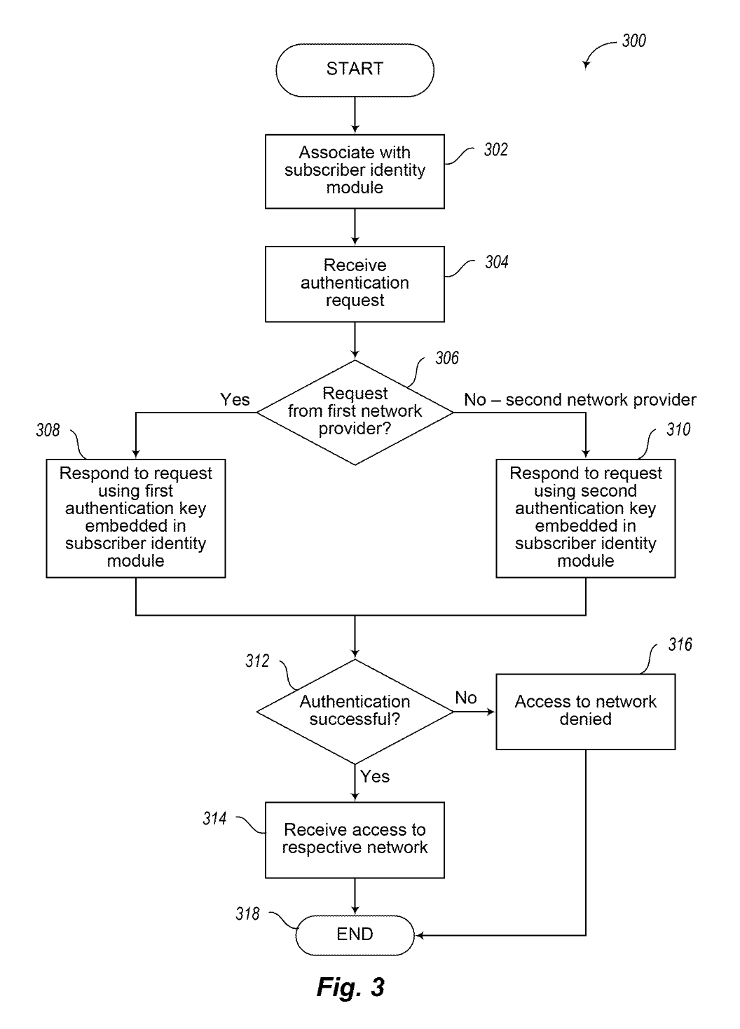

FIG. 3 shows a method 300 of real-time management of a wireless communication device to operate on multiple wireless communication networks in accordance with an embodiment herein. As briefly discussed above, a SIM associated with a wireless communication device may have more than one portion of security authentication information (e.g., an authentication key) irretrievably embedded therein. Each portion may have security authentication information required to authenticate a wireless communication device with a particular service provider's wireless communication network. In response to an authentication request from a particular network service provider's authentication system, the SIM responds by accessing a corresponding portion of security information and producing a corresponding authentication response, which is then transmitted by the wireless communication device.

The method 300 begins at 302, where a wireless communication device is associated with a SIM. At 304, an authentication request is received from a service provider's authentication system. At 306, the SIM and/or wireless communication device determines whether the request arrived from a first service provider's authentication system. If the request arrived from the first service provider's authentication system, a response to the request is generated by the SIM via a first authentication algorithm using a first authentication key embedded in the subscriber identity module at 308. For example, a request may be provided in accordance with the authentication procedure described above and utilized by different networks (e.g., GSM and CDMA). For instance, in response to an authentication request from the first service provider's authentication system including a first challenge value, the SIM may generate or produce a first challenge response based on the received first challenge value and the first secret authentication key irretrievably embedded in the SIM. The response is then transferred from the wireless communication device to the first service provider's authentication system.

If, at 306, it is determined that the request does not come from the first service provider's authentication system, it is then determined whether the request comes from a second service provider's authentication system. Accordingly, the SIM generates or produces a response to the request using a second authentication key embedded in the SIM at 310. For example, in response to an authentication request from a second service provider's authentication system including a second challenge value, the SIM generates or produces a second challenge response via a second authentication algorithm based at least in part on the received second challenge value and a second secret authentication key irretrievably embedded in the SIM. The response is then transferred from the wireless communication device to the second service provider's authentication system. The first and second authentication algorithms may be irretrievably embedded in the SIM. In another example, the first and second authentication algorithms may be stored outside the SIM (e.g., in the device memory), such that the authentication key and authentication algorithms are accessible to the necessary processing components in the device or in the SIM, as the case may be, in order to produce challenge responses. The second authentication algorithm is associated with the second service provider and is not associated with, or typically not even known by, the first service provider. The first challenge value and first authentication key may be stored by the first service provider's authentication system, and the second secret authentication key and the second challenge value may be stored by the second service provider's authentication system. At 312, the particular service provider's authentication system determines whether authentication is successful. If authentication is successful, the service provider's authentication system grants access to a wireless communication network associated with the respective service provider that generated the authenticated authentication request. If authentication is not successful, the service provider's authentication system denies access to the wireless communication network at 316. The method 300 ends at 318.

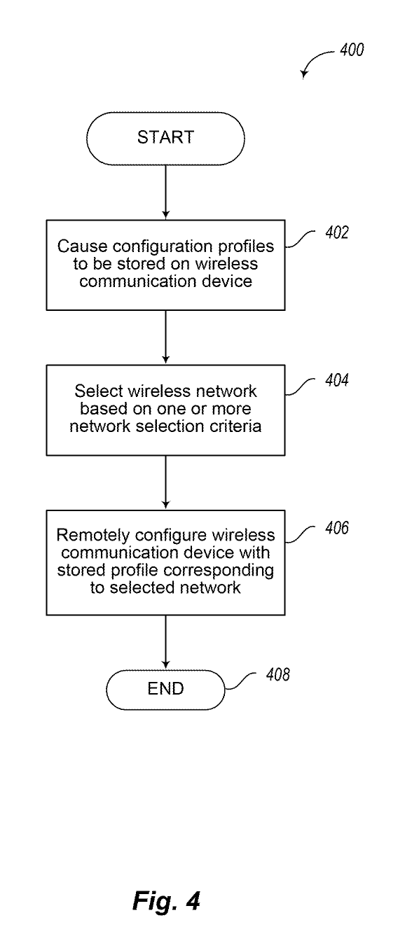

FIG. 4 shows a method 400 of real-time management of a wireless communication device to operate on multiple wireless communication networks as home wireless communication networks in accordance with another embodiment. As briefly discussed above, a wireless communication device may be remotely configured with a configuration profile corresponding to a wireless communication network selected for the operation. The selection may be based on one or more selection criteria (e.g., defined rules). The defined rules may include utilizing a particular wireless communication network at a certain time/date or set of times/dates, particular location(s), for a certain type of data (e.g., high priority data versus low priority data, international data versus local data, and the like). The defined rules may further include utilizing a particular wireless communication network based on accessible base stations, quality of transmission and reception, responsiveness, cost, and so on. A remote command may be issued to a wireless communication device to configure the device with a configuration profile corresponding to a selected wireless communication network.

The defined rules may further include utilizing a particular wireless communication network that would enable a remotely executing particular software application to communicate with the wireless device. In another example, the defined rules may further include utilizing a particular wireless communication network that would enable a locally executing software application to communicate via the wireless device over a particular network with remote entities. In an embodiment, a software application may execute remotely, e.g., on the control and command server 116 (in reference to FIG. 1) and may be configured to communicate with a wireless communication device over a particular wireless network. In order to provide the communication capability, the particular network may be selected for the device operation and the device may be remotely configured (e.g., by sending an appropriate command) to be operational on the selected network. The network selection and remote configuration of the device may be accomplished, for example, on the control and command server 116.

The process 400 begins at 402, where multiple configuration profiles are caused to be stored on a wireless communication device. For example, an entity operating the server 116 may send information comprising multiple configuration profiles and command the device to store the information. In an embodiment, the profiles may be stored on a subscriber identity module associated with the device. In another embodiment, the configuration profiles may be stored in the memory of the device. In yet another embodiment, the configuration profiles may be partially stored at either data store. At 404, a wireless network is selected for the operation of the device based on one or more network selection criteria discussed above. At 406, the device is remotely configured with a stored profile corresponding to the selected network. For example, the entity operating the server 116 may issue a command that causes the device to be configured with the profile corresponding to the selected network. The process 400 then ends at 408.

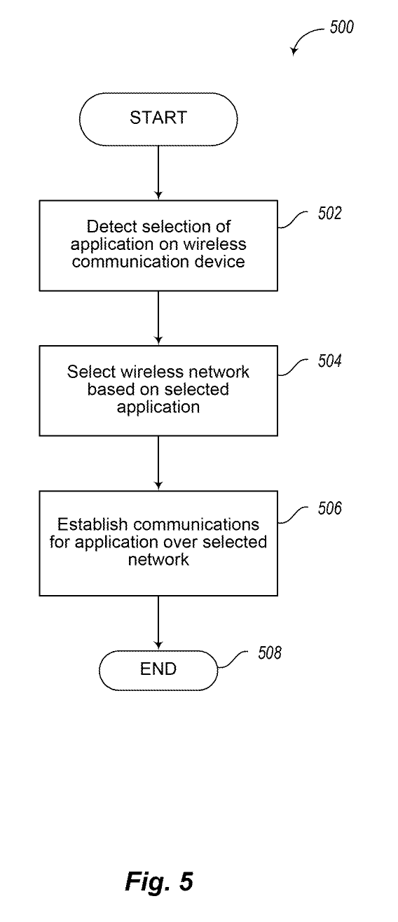

FIG. 5 shows a method of real-time management of a wireless communication device to operate on multiple networks as home wireless communication networks in accordance with yet another embodiment. A wireless communication device may self-select a wireless communication network based on one or more selection criteria. The criteria may include, but are not limited to, the defined rules as described above. For example, a selection criterion may include a designation or logical relationship between a particular software application which will execute on the wireless communication device and a particular one (or more than one, as the case may be) of a plurality of service provider wireless communication networks which the particular software application will use to correspond. Software applications configured to execute on a wireless communication device may be stored and/or execute on the wireless communication device (e.g., stored in the memory 208 and/or executed by processor 206 of the device 202, with reference to FIG. 2). Software applications may be provided by service providers or third parties and may be selected, for example, from a plurality of applications stored in the application store 118 described in reference to FIG. 1 and stored on the wireless communication device. The relationship between the applications and wireless communication networks may be based on the volume of traffic produced by the applications and wireless communication networks' capability (e.g., data traffic capacity). For example, utilizing applications associated with a wireless communication device on a particular network may increase (or, as the case may be, decrease) the volume of data traffic over the network.

The applications configured to execute on a wireless communication device may provide different functionalities, including a variety of services of interest to the end user of the wireless communication device. For example, applications may allow searching for products or services offered by electronic merchants over the Internet, determining nearby points of interest, driving routes, and the like. The applications may also be configured to sense and/or monitor different physical characteristics and/or parameters of interest, for example, via one or more transducers such as sensors. The resulting information may be used by the wireless communication device and other control units, such as may be the case with machine-to-machine wireless communication devices briefly discussed above.

In another example, applications serving a particular purpose (e.g., applications monitoring particular characteristics of interest to an electronic entity associated with one or more service providers) may be provided by third parties at a particular cost to the entity. Given a special nature of an application (e.g., better functionality, higher execution speed, and the like), the application cost may be high relative to the cost of applications provided by conventional application stores (e.g., iTunes®). A service provider may subsidize these “high-end” applications due to potential benefits provided by the application use on the wireless communication network associated with the service provider. For instance, the wireless communication network usage projection may decrease due to the use of a particular application on the network, which may be beneficial to the service provider. In another example, the cost of the application may be shared between the provider, the entity providing the applications, and the application users.

The applications may be configured to communicate with other applications, systems, or devices over a particular wireless communication network. For example, one application may be configured to communicate over a first GSM network, while another application may be configured to communicate over either a second GSM network or over a CDMA network. Accordingly, the wireless communication device may be enabled to select, from available wireless communication networks, a wireless communication network that would provide the communication capability for an application executing on the wireless communication device.

The process 500 begins at 502, where an application selection is detected on a wireless communication device. For example, a plurality of applications may reside on the wireless communication device, and the device, an entity associated with the device, or a user may select one of the plurality of applications for execution. There are different ways to detect an application selection. For example, an application may begin executing on the device. In another example, the application may receive a request for accessing and/or execution on the device. In either example, the processes related to the selection of the application may be captured and detected accordingly. At 504, a wireless communication network is selected based on the detected selection of the application. For example, it may be determined that the application is configured to communicate over the CDMA network. Accordingly, if available, the CDMA network will be selected for the device operation. It should be noted that a particular network does not have to be used exclusively based on the selected application. For example, a preference for a particular network to be used or a priority of networks to be used may be determined based on the detected application. At 506, communication is established for the application over the selected wireless communication network. The process 500 ends at 508.

As discussed above, the various embodiments can be implemented in a wide variety of operating environments which, in some cases, can include one or more computing devices, or processing devices which can be used to operate any of a number of applications. Various aspects also can be implemented as part of a Web service, such as may be part of a service-oriented architecture. Most embodiments utilize at least one network that would be familiar to those skilled in the art for supporting communication using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof

The environment can include a variety of data stores and other memory and storage media as discussed above. These can reside in a variety of locations, such as on a storage medium local to (and/or resident in) one or more of the computers or remote from any or all of the computers across the network. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). In certain types of devices, such as M2M devices, the input and output devices may not be required. Such a system may also include one or more storage devices, such as disk drives, optical storage devices, and solid-state storage devices, such as random access memory (“RAM”) or read-only memory (“ROM”), as well as removable media devices, memory cards, flash cards, and the like.

Such devices also can include a computer-readable storage media reader, a communication device (e.g., a modem, a network card (wireless or wired), an infrared communication device), and working memory as described above. The computer-readable storage media reader can be connected with, or configured to receive, a computer-readable storage medium, representing remote, local, fixed, and/or removable storage devices, as well as storage media for temporarily and/or more permanently containing, storing, transmitting, and retrieving computer-readable information. Storage media and computer-readable media for containing code, or portions of code, can include any appropriate media known or used in the art, including storage media and communication media, such as, but not limited to, volatile and non-volatile, removable and non-removable media implemented in any method or technology for storage and/or transmission of information such as computer-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the system device.

Based on the disclosure and teachings provided herein, a person of ordinary skill in the art will appreciate other ways and/or methods to implement the various embodiments. The specification and drawings are, accordingly, to be regarded in an illustrative rather than a restrictive sense. It will, however, be evident that various modifications and changes may be made thereunto without departing from the broader spirit and scope of the present disclosure as set forth in the claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet , including but not limited to U.S. patent application Ser. No. 12/579,810 filed Oct. 15, 2009; U.S. patent application Ser. No. 12/862,027 filed Aug. 24, 2010; U.S. provisional patent application Ser. No. 61/105,737 filed Oct. 15, 2008; U.S. provisional patent application Ser. No. 61/110,900 filed Nov. 3, 2008; U.S. provisional patent application Ser. No. 61/236,481 filed Aug. 24, 2009; U.S. provisional patent application Ser. No. 61/236,793 filed Aug. 25, 2009; U.S. patent application Ser. No. 12/915,255 filed Oct. 29, 2010; U.S. provisional patent application Ser. No. 61/256,840 filed Oct. 30, 2009; and U.S. provisional patent application Ser. No. 61/546,943 filed Oct. 13, 2011, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method of operating a subscriber identity module associated with a wireless communication device, the method comprising:
in response to receiving a first authentication request from an authentication system under control of a first wireless communication network service provider including a first challenge value, producing a first challenge response by the subscriber identity module via a first authentication algorithm based at least in part on the received first challenge value and a first secret authentication key irretrievably embedded in the subscriber identity module, the first authentication algorithm associated with the first wireless communication network service provider, the secret authentication key and the first challenge value associated with at least the authentication system under the control of the first wireless communication network service provider; and
in response to receiving a second authentication request from an authentication system under control of a second wireless communication network service provider including a second challenge value, producing a second challenge response by the subscriber identity module via a second authentication algorithm based at least in part on the received second challenge value and a second secret authentication key irretrievably embedded in the subscriber identity module, the second authentication algorithm associated with the second wireless communication network service provider and not associated with the first wireless communication network service provider, the second secret authentication key and the second challenge value associated with at least the authentication system under the control of the second wireless communication network service provider.

2. The method of claim 1, wherein the first and the second wireless communication network service providers are associated with first and a second wireless communication networks respectively.

3. The method of claim 2, wherein the first and the second wireless communication networks are selected from at least one of a GSM network and a CDMA network.

4. The method of claim 1, wherein the subscriber identity module is selected from at least one of a GSM SIM card, an R-UIM card, or a portion of a wireless communication device memory dedicated to storing information associated with the subscriber identity module.

5. The method of claim 1, wherein the subscriber identity module irretrievably embeds the first and the second authentication algorithms.

6. The method of claim 1, wherein the subscriber identity module accesses the first and the second authentication algorithms that are stored outside of the subscriber identity module.

7. A method for remotely configuring a wireless communication device, comprising:
causing, by at least one computer system, a plurality of configuration profiles for respective ones of each of a plurality of wireless networks to be stored on a wireless communication device;
determining, by the at least one computer system, which of the plurality of wireless networks corresponds to one or more defined wireless network selection criteria; and
remotely configuring, by the at least one computer system, the wireless communication device with one of the stored configuration profiles which corresponds to the determined wireless network, the configuration profile configuring the wireless communication device for wireless communication over the determined wireless network.

8. The method of claim 7, further comprising:
sending an update to the configuration profiles to the wireless communication device; and
causing the update to be associated with a corresponding at least one of the configuration profiles.

9. The method of claim 8, wherein the update is sent via at least one of a wireless communication network on which the device currently operates, a Wi-Fi network, or a direct wired connection.

10. The method of claim 7, wherein determining which of the plurality of wireless networks corresponds to one or more defined wireless selection criteria includes determining which of the plurality of wireless networks is logically associated with one or more software applications executing remotely on the at least one computing system or on a second computing system associated with the wireless communication device.

11. The method of claim 10, wherein the one or more software applications are provided by a third party via the at least one computing system.

12. The method of claim 10, wherein remotely configuring the wireless communication device with one of the stored configuration profiles changes a home wireless communication network of the wireless communication device.

13. A method for configuring a wireless communication device, comprising:
detecting, by at least one processor, a selection of a first application on the wireless communication device, the first application being selected from one or more applications associated with the device;
selecting, by the at least one processor, a first wireless communication network from a plurality of wireless communication networks based on the selected first application; and
establishing, with the at least one processor, wireless communication for the selected first application over the selected wireless communication network by the wireless communication device.

14. The method of claim 13, further comprising:
configuring the wireless communication device with a stored configuration profile corresponding to the selected wireless communication network before establishing wireless communication for the first application over the selected wireless communication network.

15. The method of claim 13, wherein at least one of the one or more applications is associated with a provider of at least one of the plurality of wireless communication networks.

16. The method of claim 13, wherein at least a subset of the one or more applications is selected from an application store maintained by a third party.

17. The method of claim 13, wherein establishing wireless communication for the selected first application includes establishing wireless communication as a home wireless communication network.

18. The method of claim 13, wherein selecting a first wireless communication network from a plurality of wireless communication networks based on the selected first application further includes selecting a wireless communication network priority governed by the selected first application.
